(19) United States
(12) Patent Application Publication
(10) Pub. No.: US 2022/0335641 A1
(43) Pub. Date: Oct. 20, 2022

(54) DIGITAL FIT TOOL FOR MEASUREMENT OF BRA SIZE

(71) Applicant: Wacoal America, Inc., New York, NY (US)

(72) Inventors: Miryha Fantegrossi, Westport, CT (US); Naji Farhat, Westport, CT (US)

(73) Assignee: Wacoal America, Inc., New York, NY (US)

(21) Appl. No.: 17/668,305

(22) Filed: Feb. 9, 2022

Related U.S. Application Data
(60) Provisional application No. 63/174,985, filed on Apr. 14, 2021.

(51) Int. Cl. G06T 7/62; G06V 40/10; G06Q 30/06

(52) U.S. Cl. CPC G06T 7/62; G06V 40/103; G06Q 30/0643; G06Q 30/0631; G06T 2207/30196

(57) ABSTRACT

A method for automatically providing garment size and style recommendations for a wearer is disclosed. The wearer is guided via a mobile device to take one or more full-body digital images which are analyzed to generate the wearer's measurements. Over bust, under bust, front bust, and volume measurements are generated. A rounded band measurement based on at least the under bust measurement, and a rounded volume measurement based on at least the volume measurement are determined. A bra size recommendation comprising a recommended band size, wherein the rounded band measurement is within an optimal band range for the band size in at least one sizing table, and a recommended cup size, and the cup size on the rounded volume measurement is within an optimal volume range for the cup size in the at least one sizing table, is transmitted to the user device for display on the user interface.

### CROSS-REFERENCE TO RELATED APPLICATION

This application claims priority to U.S. Provisional Application Ser. No. 63/174,985, filed on Apr. 14, 2021, entitled “DIGITAL FIT TOOL FOR MEASUREMENT OF BRA SIZE”. The content of this application is incorporated by reference in its entirety for all purposes.

### BACKGROUND

The present invention relates generally to bra size measurement and bra style recommendation related systems and methods. More specifically, embodiments of the present invention relate to mobile device applications that provide fast, automated bra fitting and expert product and style recommendations on a customer's mobile device without need for a measuring tape, or entering a physical store and meeting with an in-person professional bra fitter.

The background description includes information that may be useful in understanding the present invention. It is not an admission that any of the information provided herein is prior art or relevant to the presently claimed invention, or that any publication specifically or implicitly referenced is prior art.

In this specification, the term “bra” refers not just to the garment commonly referred to as a bra or brassiere that is worn to support and cover a woman's breasts, but all clothing designed to closely fit or provide support for a wearer's breast or breasts, including other types of bodywear, lingerie, sportswear, or shapewear such as bodysuits, swimsuits, leotards, etc.

Finding the correct size bra for one's body is a notoriously difficult endeavor. Many women don't know their correct bra size, for example, and are never measured (or are inaccurately measured) for bra size, either by a professional bra fitter or otherwise. Women often make a rough guess at their approximate bra size by looking at the bras that they own and wear on a daily basis, and then shopping for bras in that size. A typical way to shop for bras can be a trial-and-error process: for example, a woman may pick styles or brands that look appealing, regardless of whether these styles or brands are designed or cut to fit her body shape and size. Alternatively, women shopping for bras may just try on a variety of brands and styles of what is available in the store in the size that they think they are, hoping to find a bra or bra that fits and is comfortable. Thus, bra shopping can be a long and arduous process, and often results in purchasing bras that are uncomfortable or not the correct size. When shopping for bras online or from home, the option of trying on a bra for fit is much more restricted, since if the bra does not fit, it must be returned to the seller, with of the attendant hassles and delays from returning merchandise in store or via return shipping within the return time window, tracking one's refund, and then selecting and purchasing another bra or bras to try again to find a comfortable bra that fits well.

Furthermore, wearing an ill-fitting bra or the wrong bra size can affect how clothing fits the body, and possibly ruin one's appearance while wearing a fashionable outfit. More importantly, incorrectly fitting bras can cause discomfort such as breast pain and backaches, particularly for individuals with larger breasts. Women of all sizes can relate to uncomfortable and incorrectly fitting bras where underwire pokes at the sides of one's breasts, where bands ride up, where the bra hikes up when one lifts one's arms, where bra straps are constantly slipping off one's shoulders, or bra cups where the breast tissue spills over the cup, or where the bra cup is wrinkled while you are wearing it.

Bra size is also notoriously fickle between different lingerie brands; a C-cup for one store or lingerie brand can easily be a D-cup at another, and some bra sizes can grow and shrink (especially in band size) over the course of a day, over the time the bra is owned and worn, or between washings. A woman's bra size can also change over time. For example, the size and shape of breasts can vary at different times in the menstrual cycle. Changes can occur in one's breast during and after pregnancy, or as one ages. Weight gain or loss, a new exercise regimen, or dietary changes may also cause one's bra size to change over time. Thus, it may be necessary to measure one's bra size at different intervals. Finding a professional bra fitter each time one's bra size changes can be a hassle, particularly when one's busy schedule of family and work obligations, or outside factors such as store closures make going into a local brick-and-mortar store to shop for bras difficult. Many shoppers may also not be comfortable being measured in a semi-naked state by a stranger, so the experience can be awkward and hurried, and the bra size and style recommendations may not be optimal.

For this reason, many lingerie store and manufacturer's websites, fashion blogs, and women's magazine articles offer guidance on how to measure one's own bra size at home using a measuring tape, for example. Such guidance generally involves using a measuring tape to measure around one's torso directly under one's bust, where a bra band would sit; and then wrapping the measuring tape around the fullest part of one's chest, at the most projected point or apex The difference between these two measurements can then be used to determine a cup size, for example. However, measuring one's own body, or having a friend or relative measure one's body, with a measuring tape can yield inaccurate or inconsistent results, particularly for those who are not experts (e.g., fashion designers, or experienced sewers or crafters who make or sew their own clothing). One may not even have a measuring tape handy. Self-measurement of one's own bra size therefore is often an ineffective method of bra fitting.

Not surprisingly, attempts have been made over the years to develop methods and devices for more accurate self-measurement of breasts and bras, and to provide bra style recommendations. Several bra and lingerie brands and manufacturers have developed online “quizzes” that start with the customer entering their bra size (either the bra size they currently wear, or a bra size obtained through self-measurement or otherwise), and then make a size recommendation based on the customer's subjective responses to how that size feels, which may yield inaccurate size recommendations. Other methods and devices for measurement of bra sizes can be somewhat cumbersome, and may involve providing a separate measurement device or devices to the consumer. For example, U.S. Pat. No. 7,162,441 to Nabarro describes a breast measuring method that in addition to the aforementioned measuring tape, also involves applying a plurality of receptacles, each of a different known volume and/or shape, in turn to the user's breast, and selecting the receptacle giving the most comfortable supporting fit to the user's breast to help determine the size. See Nabarro, col. 6, line 52 to col. 7, line 51. The user would need to be provided with a set of such receptacles before she can measure herself and start shopping, and would need to first wait to have the devices shipped to her home, adding further delay, expense and hassle to the bra fitting and selection process.

A more convenient, user-friendly and lower cost method for accurately measuring and fitting bra size of a wearer, and automatically and instantaneously providing bra size and style recommendations to a wearer that may be used in the privacy of one's own home, using only a smartphone or other user device, without using a measuring tape or special devices that need to be shipped to the wearer is therefore needed.

### SUMMARY

Embodiments of the present invention relate to mobile device applications that provide fast, automated bra fitting and expert product and style recommendations on a customer's mobile device without need for a measuring tape, or entering a physical store and meeting with an in-person professional bra fitter, by using digital image captures of a customer's body to determine body measurements and other digital data to automatically generate and provide accurate bra size measurement and bra style recommendations to the customer.

Systems and methods of enabling a business to ensure a best fit of bras and other garments to its customers based on photographic images or video capturing the physical characteristics of the customer's body, torso, and/or chest or bust area are disclosed. As discussed above in the background section, in the bra and lingerie industry a customer's best or optimal bra fit is typically determined by measuring size. Embodiments of the present invention disclosed herein provide an innovative digital fit tool designed to run on common mobile user devices such as smartphones, laptop computers, or tablets, that automatically provides a customer with a solution-based recommended bra and/or lingerie wardrobe that takes into account both a customer's size and breast shape. This digital fit tool automatically delivers a time-efficient, easy-to-use bra fitting experience that will, within minutes, deliver accurate bra size information and customized, size-specific product recommendations to the customer from the comfort of home, and without any measuring tapes, special tools, devices, or human fit experts needed.

A method for automatically providing garment size and style recommendations for a wearer is disclosed. The wearer is guided via a mobile device to take one or more full-body digital images which are analyzed to generate the wearer's measurements. Over bust, under bust, front bust, and volume measurements are generated. A rounded band measurement based on at least the under bust measurement, and a rounded volume measurement based on at least the volume measurement are determined. A bra size recommendation comprising a recommended band size, wherein the rounded band measurement is within an optimal band range in at least one sizing table, and a recommended cup size, and the cup size on the rounded volume measurement is within an optimal volume range for the cup size in the at least one sizing table, is transmitted to the user device for display on the user interface. The at least one sizing table may be generated using regression analysis based on a database of real world measurement samples.

### BRIEF DESCRIPTION OF THE DRAWINGS

For a better understanding of the various described aspects, reference should be made to the detailed description below, in conjunction with the following figures in which like-referenced numerals refer to corresponding parts throughout the figures.

FIG. 1 illustrates a block diagram of the data flow and architecture of a system according to some embodiments of the present invention;

FIG. 2 illustrates a flow diagram of an exemplary customer experience process according to some embodiments of the present invention;

FIG. 2A illustrates two exemplary screenshots of a user interface of the exemplary customer experience process shown in FIG. 2;

FIG. 3 illustrates a flow diagram of an image capture process according to some embodiments of the present invention;

FIG. 3A illustrates three exemplary images that may be taken as part of the image capture process of FIG. 3;

FIG. 3B illustrates two exemplary images that may be taken as part of the image capture process of FIG. 3;

FIG. 4 illustrates a flow diagram of a bra size and style recommendation method according to an embodiment of the invention;

FIG. 5A illustrates an exemplary screenshot of a shape self-assessment questionnaire according to an embodiment of the invention;

FIG. 5B illustrates an exemplary screenshot of a shape self-assessment questionnaire according to an embodiment of the invention;

FIG. 5C illustrates an exemplary screenshot of a shape self-assessment questionnaire according to an embodiment of the invention;

FIG. 5D illustrates an exemplary screenshot of a shape self-assessment questionnaire according to an embodiment of the invention;

FIG. 5E illustrates an exemplary screenshot of a shape self-assessment questionnaire according to an embodiment of the invention;

FIG. 6 illustrates an exemplary screenshot of a bra size and style recommendation user interface display according to an embodiment of the invention;

FIG. 7 illustrates a flow diagram of a bra size determination method according to an embodiment of the invention;

FIG. 8 illustrates a flow diagram of another bra size determination method according to an embodiment of the invention;

FIG. 9 illustrates a portion of an exemplary sizing table according to an embodiment of the invention;

FIG. 10 illustrates a block diagram of a distributed computer system that can implement one or more aspects of an embodiment of the invention; and

FIG. 11 illustrates a block diagram of an electronic device that can implement one or more aspects of an embodiment of the invention.

While the invention is described with reference to the above drawings, the drawings are intended to be illustrative, and the invention contemplates other embodiments within the spirit of the invention.

### DETAILED DESCRIPTION

The following description is presented to enable any person skilled in the art to make and use embodiments of the invention and is provided in the context of particular applications and their requirements. Various modifications to the exemplary embodiments will be readily apparent to those skilled in the art, and the generic principles defined herein may be applied to other embodiments and applications without departing from the spirit and scope of the invention. Thus, the present invention is not intended to be limited to the embodiments shown but is to be accorded the widest scope consistent with the principles and features disclosed herein.

The various embodiments now will be described more fully hereinafter with reference to the accompanying drawings, which form a part hereof, and which show, by way of illustration, specific examples of practicing the embodiments. This specification may, however, be embodied in many different forms and should not be construed as limited to the embodiments set forth herein; rather, these embodiments are provided so that this specification will be thorough and complete, and will fully convey the scope of the invention to those skilled in the art. Among other things, this specification may be embodied as methods or devices. Accordingly, any of the various embodiments herein may take the form of an entirely hardware embodiment, an entirely software embodiment or an embodiment combining software and hardware aspects. The following specification is, therefore, not to be taken in a limiting sense.

Throughout the specification and claims, the following terms take the meanings explicitly associated herein, unless the context clearly dictates otherwise. The phrases “in one embodiment,” “in an embodiment,” and the like, as used herein, does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” includes plural references. The meaning of “in” includes “in” and “on.”

It is noted that description herein is not intended as an extensive overview, and as such, concepts may be simplified in the interests of clarity and brevity.

Any process described in this application may be performed in any order and may omit any of the steps in the process. Processes may also be combined with other processes or steps of other processes.

All publications, patents and patent applications referred to herein are incorporated by reference in their entirety to the same extent as if each individual publication, patent or patent application was specifically and individually indicated to be incorporated by reference in its entirety.

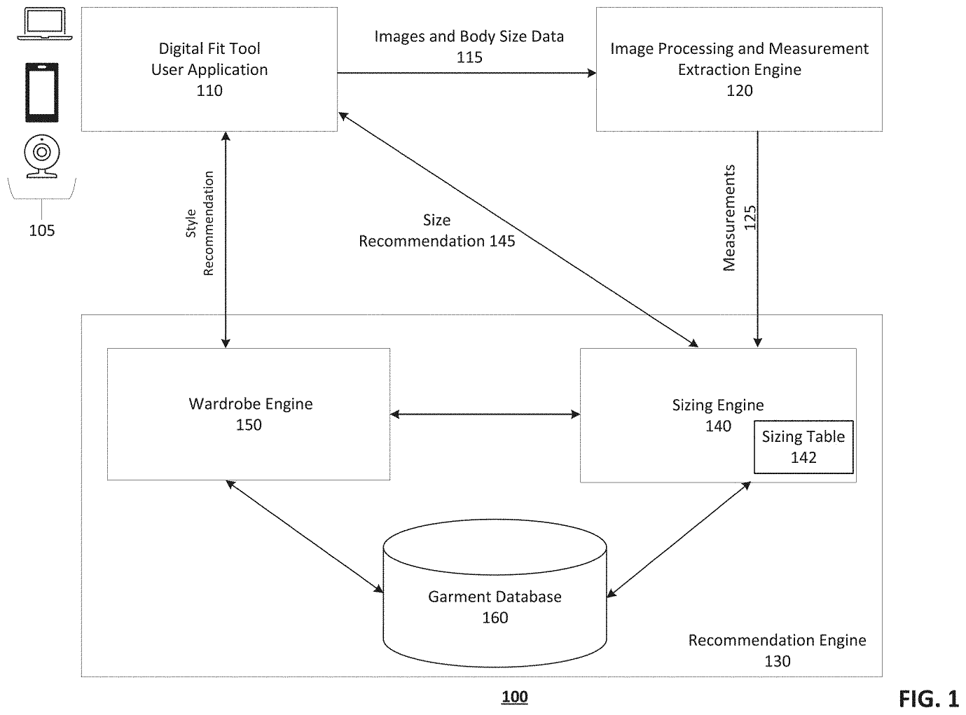

FIG. 1 illustrates a block diagram of the data flow and architecture of a bra size fitting and style recommendation system 100 according to some embodiments of the invention. A user or wearer desiring to measure herself or themselves for bra size and having an end user device 105 such as a smartphone, tablet, laptop or desktop computer equipped with a webcam, may download digital fit tool user application 110 onto the memory of the end user device 105. One or more embodiments of digital fit tool user application 110 may be produced, used, and/or marketed by Wacoal America, Inc. of New York, N.Y., under one or more names, including the name mybraFit™ owned by Wacoal America, Inc. When the user launches the digital fit tool user application 110 from device 105, application 110 will direct the user to use the device 105 to take one or more digital images and to input one or more body size data elements (e.g., self-reported height of the user and self-reported weight of the user), and will transmit the images and body size data 115 to image processing and measurement extraction engine 120.

In one embodiment of the invention, image processing and measurement extraction engine 120 may be located outside recommendation engine 130 at a site remote from engine 130, and may comprise systems and methods such as those described in U.S. Pat. No. 9,727,787 to Wilf et al., entitled “System and Method for Deriving Accurate Body Size Measures from a Sequence of 2D Images,” which is herein incorporated by reference in its entirety. However, it is contemplated that image processing and measurement extraction engine 120 is not limited to a particular embodiment, and may also alternatively be located within recommendation engine 130, and/or at the same site as engine 130. Other embodiments of the invention may comprise any one of several 2-D and/or 3-D body scanning and garment size measurement applications currently available on the market and known to those skilled in the art. Such exemplary 2-D and/or 3-D body scanning and garment size measurement applications may include applications manufactured and marketed by vendors such as 3DLOOK of San Mateo, Calif. (website at 3dlook.me), or Nettelo, Inc. of Westlake Village, Calif. (website at nettelo.com).

In one embodiment of the invention, image processing and extraction engine 120 extracts one or more body size measurements 125 and transmits the measurements to sizing engine 140, which is located within recommendation engine 130 along with wardrobe engine 150 or garment database 160. Alternatively, any of sizing engine 140, wardrobe engine 150, or garment database 160 may also alternatively be located outside of recommendation engine 130 or at a different site remote from recommendation engine 130. In one embodiment of the invention, sizing engine 140 may perform one or more lookup functions on sizing table 142. Sizing engine 140 then computes size recommendation 145 and transmits the size recommendation 145 directly to Digital Fit Tool User Application 110 for display on a user interface presented to the user. Sizing engine 140 also transmits body size measurements 125 and/or size recommendations 145 to wardrobe engine 150 and garment database 160 within recommendation engine 130. Wardrobe engine 150 may receive breast shape data and/or style preferences from the user at application 110, and may query garment database 160 to identify a plurality of style recommendation 155 for presentation to the user via a user interface of application 110.

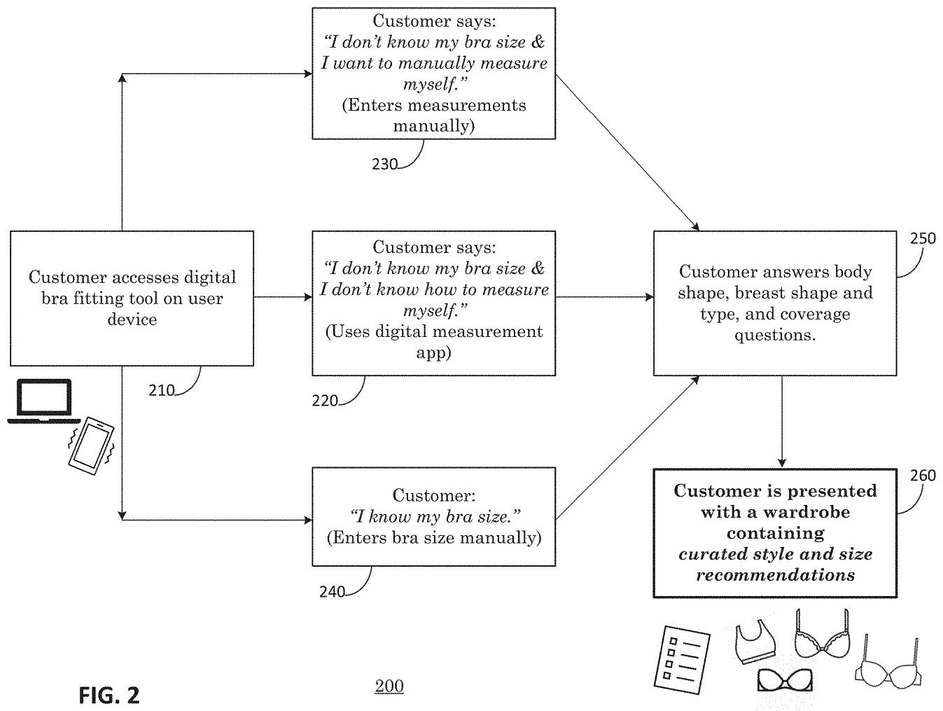

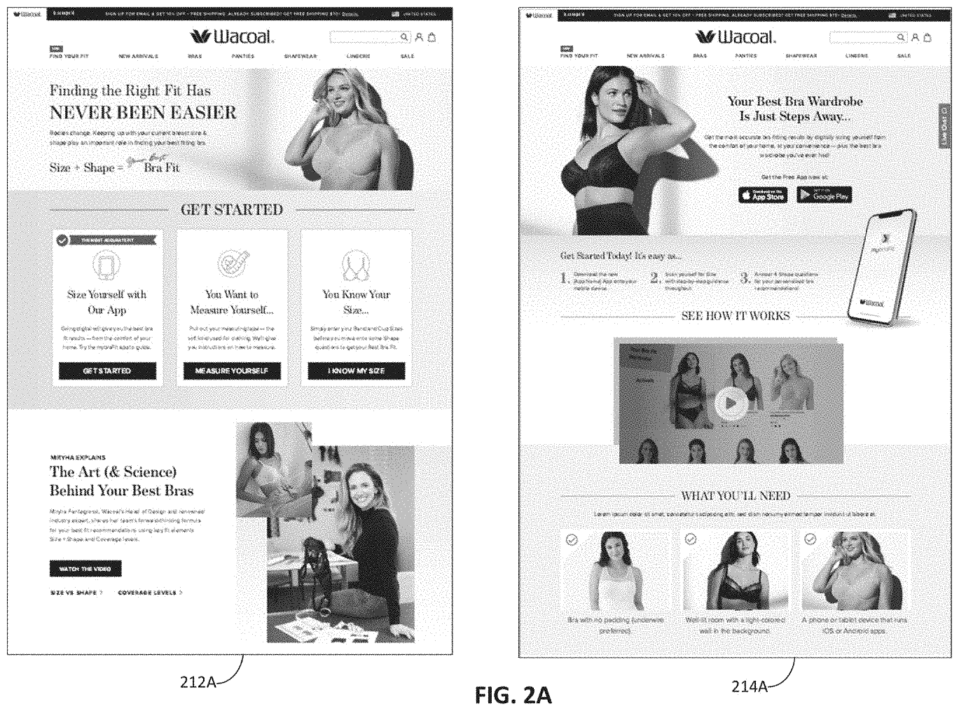

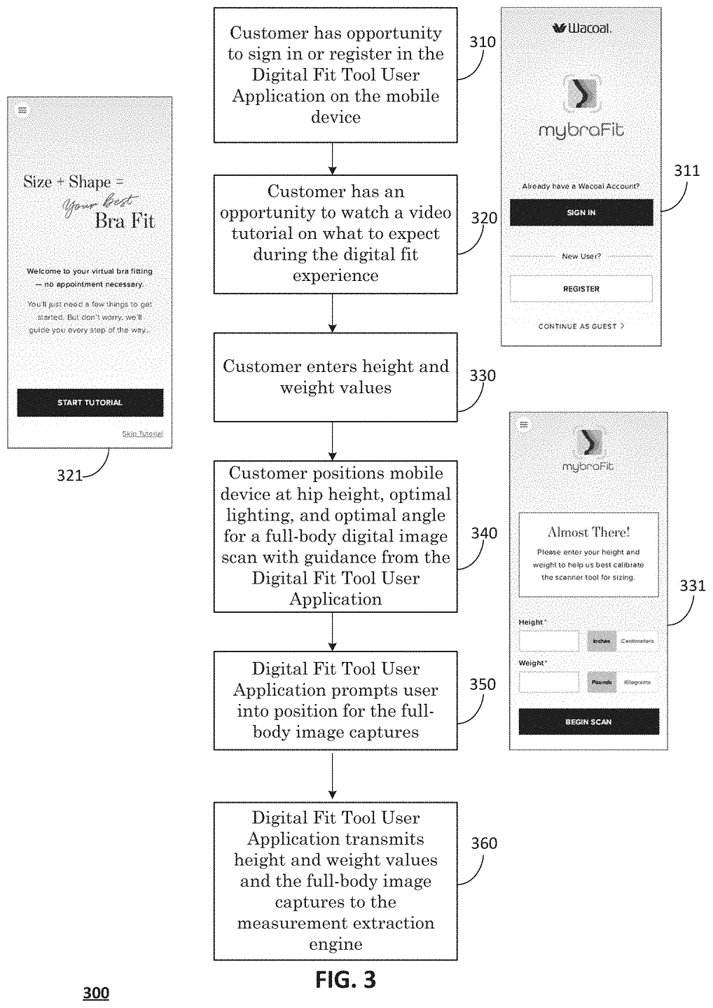

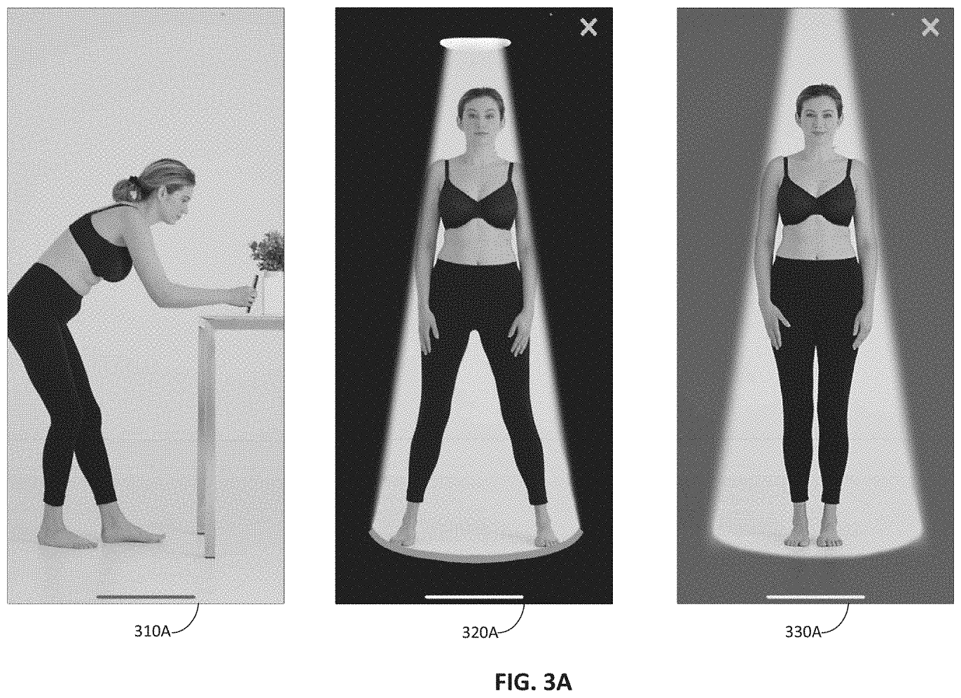

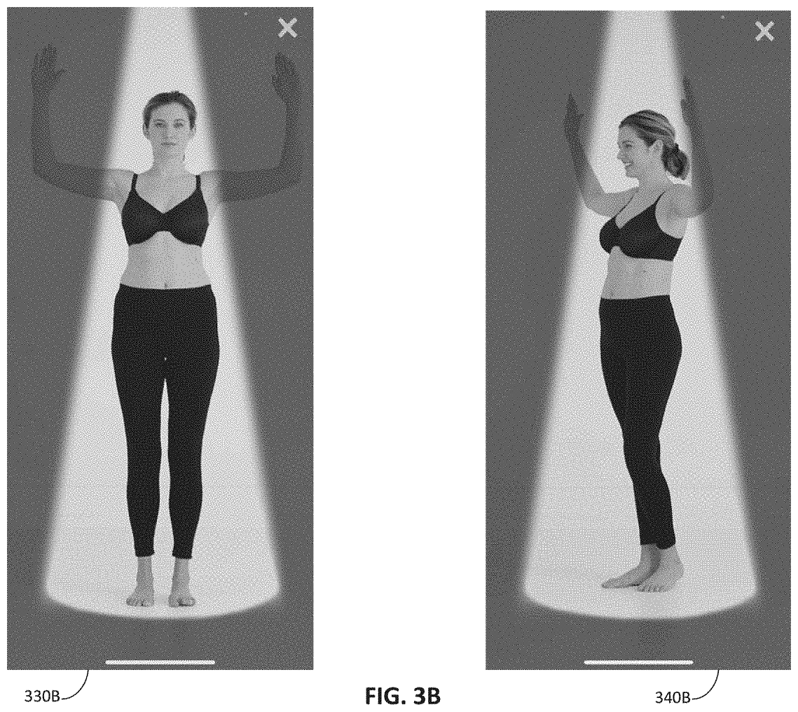

FIG. 2 illustrates a flow diagram of an exemplary customer experience process 200 according to some embodiments of the invention. FIG. 2A illustrates two exemplary screenshots of a user interface of the exemplary customer experience process shown in FIG. 2 and discussed herein. At step 210, the customer accesses digital fit tool user application 110 on their user device as described above and, in one embodiment of the invention, may be presented with an exemplary user interface screen as shown in screenshot 212A of FIG. 2A. On application 110, the customer may, for example, say to herself at step 220, “I don't know my bra size, and I don't know how to measure myself.” At that point, application 110 will initiate a process and user interface, an example of which used in one embodiment of the invention is shown at 214A of FIG. 2A, on the client user device to guide the customer to take a plurality of full-body digital image captures of the customer, and transmit the plurality of full-body digital image captures, along with body measurement and/or description data provided by the customer to image processing and measurement extraction engine 120 to generate a bra size recommendation. Alternatively, the customer may be directed or presented with the option to download a mobile device application on her user device, e.g. smartphone, to take the full-body digital image captures, as discussed below with respect to FIG. 3.

If the customer does not know their bra size and does not want to take the plurality of full-body digital image captures for automated bra fitting and measurement as described above, the customer may elect at step 230 be presented with a video tutorial and/or to review some instructions on how to measure herself manually using a physical measuring tape, and enter these measurements on the user interface of application 110, which will transmit the measurements directly to sizing engine 140. Alternatively, the customer may already know their bra size and may simply proceed to enter the bra size on the user interface of application 110, which will transmit the bra size data directly to sizing engine 140, at step 240.

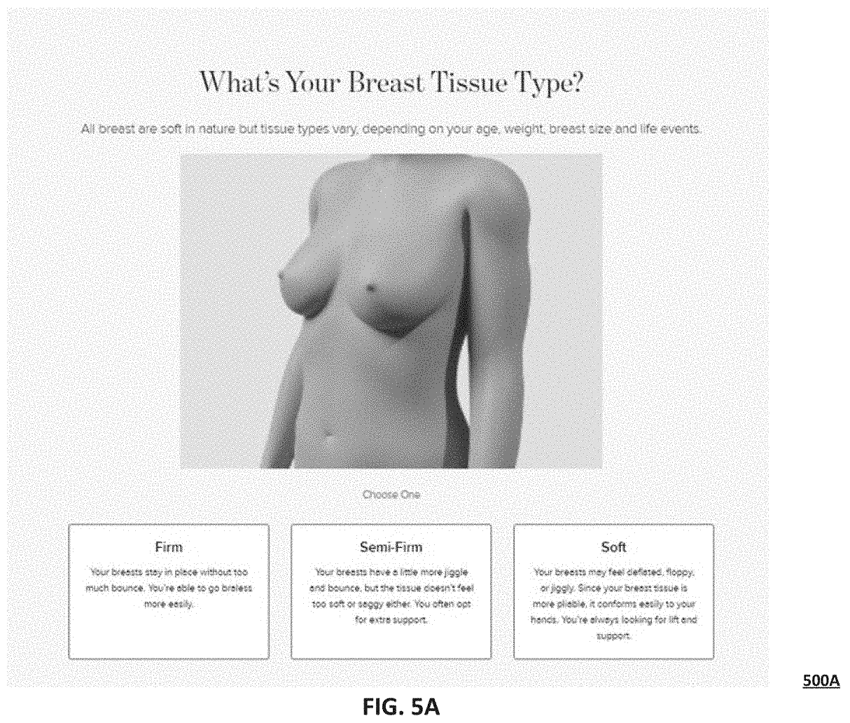

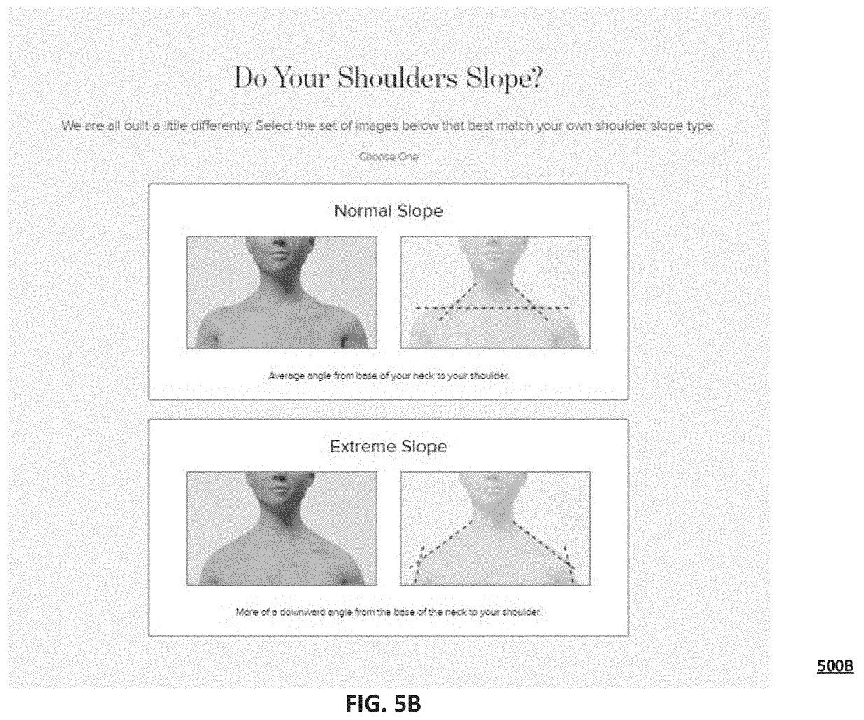

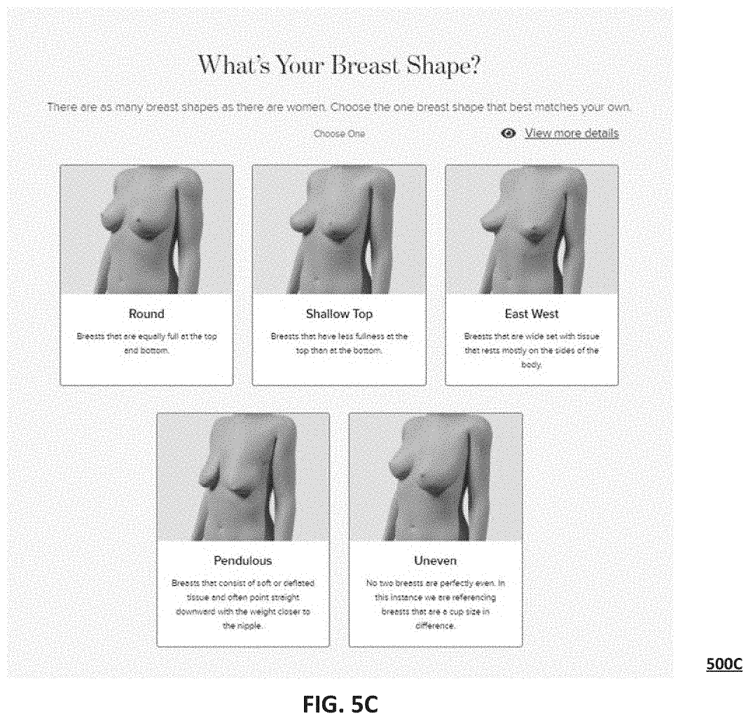

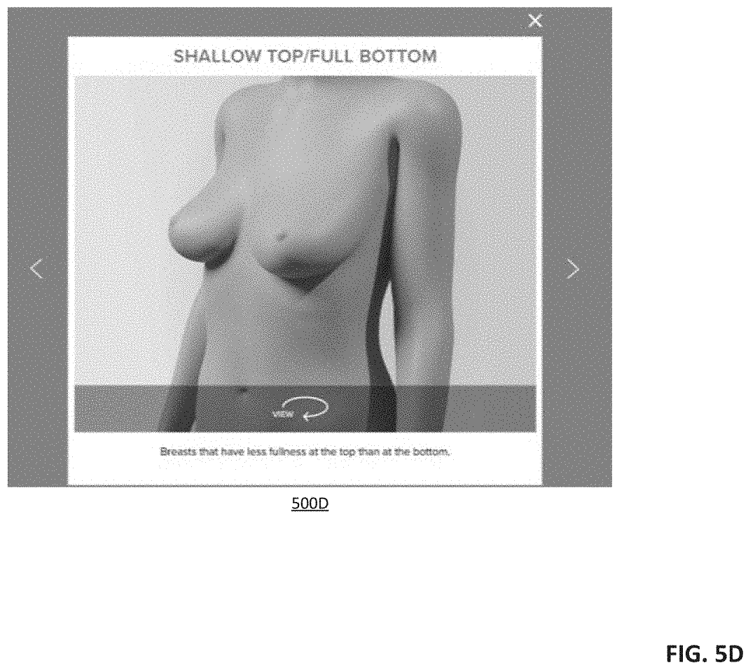

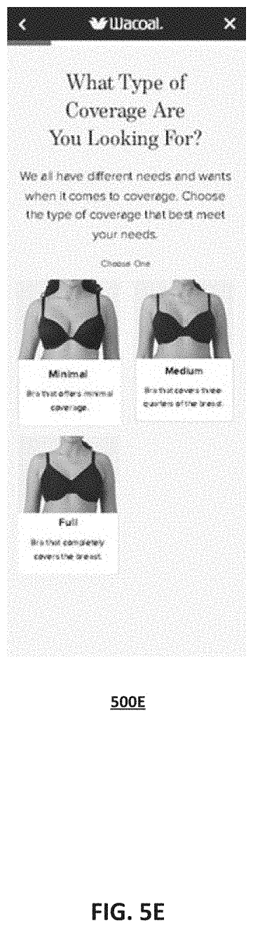

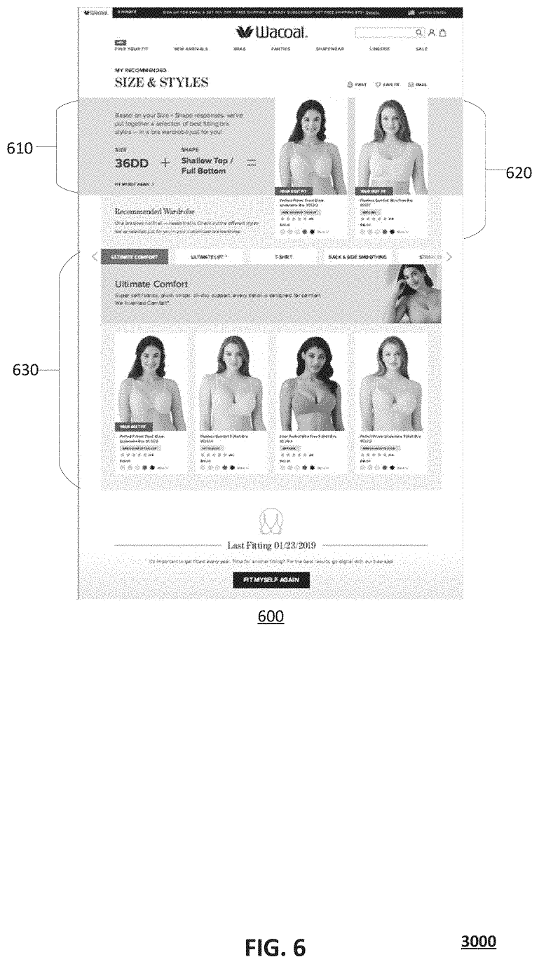

Once the customer has completed any one of steps 220, 230, or 240, the customer is directed to an interface to answer a plurality of questions about body shape, breast shape, breast type, and coverage at step 250. Screenshots 410-440 of an exemplary user interface showing an example set of customer shape- and style-related questions used in one embodiment of the invention is discussed below with respect to FIG. 5. The responses input by the customer into the user interface of application 110 are transmitted to wardrobe engine 150 within recommendation engine 130. Wardrobe engine 150 communicates with sizing engine 140 and searches garment database 160 to generate, in real-time or substantially in real-time, one or more size and style recommendations at step 260, which may comprise together a “wardrobe” containing curated size and style recommendations of a plurality of different garments, such as bras, chemises, shapewear, or other clothing and lingerie items, which is customized to the customer's automatically generated or manually measured bra size and shape, and style preferences and presented to the user via the user interface of application 110. An exemplary screenshot used in one embodiment of the invention showing an example user interface displaying bra size and curated wardrobe recommendations to the customer is shown at FIG. 6 as discussed below.

FIG. 3 illustrates a flow diagram of an image capture process 300 according to some embodiments of the invention. At step 310, the customer has an opportunity to sign in or register in the Digital Fit Tool User Application 110 on her mobile device, at which time exemplary interface 311 may be displayed on the user device. At step 320, the customer has an opportunity to watch a video tutorial on what to expect during the digital fit experience, at which time exemplary interface 321 may be displayed on the user device. The video tutorial may provide guidance such as suggested clothing to wear during the digital fit experience, how to select a well-lit room or area for capturing one or more hands-free digital image scans, and how to position the customer's mobile device and where to stand to capture the hands-free digital scans. In one embodiment of the invention, the customer is suggested to wear her/their best fitting bra (non-p added bra is preferred) and fitted pants such as leggings or slim fit jeans, and no shoes. At step 330, the customer enters data such as customer height and weight values, as needed and not captured during the image capture process, at which time exemplary interface 331 may be displayed on the user device.

The customer may initiate the image scanning/capture process after entering the height and weight values at exemplary interface 331. In one embodiment of the invention, the customer may prop her mobile user device, e.g. smartphone, up on a flat surface, at hip level as shown in step 340 of FIG. 3. The scan process guides the user/customer to ensure the proper placement of the user device camera as noted above, and may provide guidance via displaying image 310A of FIG. 3A. In some embodiments of the invention, a gyroscope in the mobile user device may be displayed on the mobile user device to guide the user on proper angle placement for the phone prior to image capture (e.g., by propping the phone up against an object such as a stack of books or a plant pot on a table, or using an adjustable phone stand).

Embodiments of the present invention present a user interface on the mobile user device that will then proceed to indicate what distance a user should stand so that the user's body from the top of her head to her feet are visible as shown in step 350 of FIG. 3. Error messages may be generated if the user's head and/or feet or not in view, or if the customer is wearing too much or loose clothing, for example. Error messages may also be generated if the lighting is too dark, or if the camera moves during the image capture process.

The user interface of application 110 will proceed to guide the user through several full-body image scans taken using the device's camera. In one embodiment of the invention, the customer will be guided to stand with hands at her sides and feet apart at approximately hip width as shown in image 320A of FIG. 3A, and then stand with feet together as shown in image 330A of FIG. 3A. The customer may then be further guided to raise her arms away from her body while in a standing position, with hands up, and turn her full body around 360 degrees while standing in one location on the floor, two positions of which are as shown in images 330B and 340B of FIG. 3B. Once the digital images are captured, the height and weight values, and the full-body image captures are automatically transmitted by the application 110 to the measurement extraction engine 120 as shown in step 360 of FIG. 3. In one embodiment of the invention, the image captures are not retained on the user device, nor are they presented to or visible to the customer via digital fit tool user application 110.

In one embodiment of the invention, measurement extraction engine 120 processes the digital images to remove any customer identifying information, and to extract body size measurements as described above. In one embodiment of the invention, the following body size measurements are generated by the measurement extraction engine and are transmitted directly to recommendation engine 130: over bust circumference, under bust circumference, front bust measurement, and volume measurement. The body size measurements are not directly visible to the customer via digital fit tool user application 110. Once the measurements are generated, the customer's images are no longer needed and may be deleted by measurement extraction engine 120 after the measurement extraction process is complete.

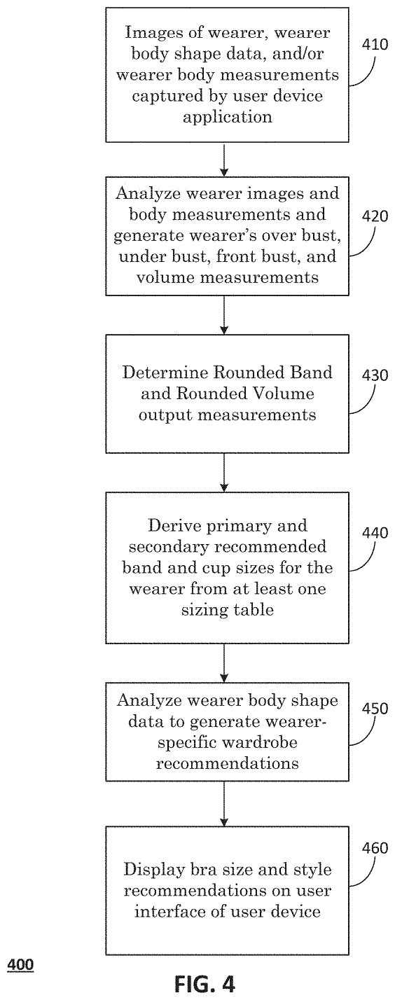

FIG. 4 illustrates a flow diagram of a bra size and style recommendation method according to an embodiment of the invention. At step 410, one or more image captures of a wearer and wearer body measurement data is received at a user device and transmitted from the user device to measurement extraction engine 120. At step 420, measurement extraction engine 120 analyzes the image captures and body measurement data, and generates the wearer's over bust, under bust, front bust, and volume measurements, and transmits the wearer's measurements to sizing engine 140 within recommendation engine 130. At step 430, sizing engine 140 determines the rounded band and rounded volume output measurements. At step 440, sizing engine 140 further determines primary and secondary recommended band and cup sizes for the wearer from at least one sizing table. At step 440, the primary and secondary recommended band and cup sizes are also transmitted from sizing engine 140 to wardrobe engine 150 and garment database 160. Wardrobe engine 150 also receives wearer body shape data from Digital Fit Tool User Application 110 (and/or alternatively image processing and measurement extraction engine 120 or sizing engine 140), and analyzes the wearer body shape data and primary and secondary band and cup sizes to generated wearer-specific bra wardrobe recommendations at step 450. At step 460, the wearer's recommended bra size and the wearer-specific bra wardrobe recommendations are transmitted to application 110 and displayed on the user device.

As discussed above, in one embodiment of the invention, customers may provide breast and body shape data to recommendation engine 130 via digital fit tool user application 110. In one embodiment of the invention, the user/customer may be presented with an interface 500A as shown in FIG. 5A to select from one of several breast tissue types, e.g.,: Firm (“Your breasts stay in place without too much bounce, and your fingers don't sink deeply into the tissue when you press on them. You are able to go braless more easily.”); Semi-Firm (“Your breasts have a little more jiggle and bounce, but the tissue doesn't feel too soft or saggy either. When you press, there is some give. You often opt for extra support.”); and Soft/Saggy (“Your breasts may feel deflated, floppy, or jiggly. Since your breast tissue is more pliable, it conforms to your hands. You're always looking for fit and support.”). In one embodiment of the invention, the exemplary interface 500B shown in FIG. 5B may be presented to the user to select a shoulder slope type (e.g., normal slope with an average angle from the base of the user's neck to the shoulder; or extreme slope with more of a downward angle from the base of the user's neck to the shoulder).

An exemplary interface as shown in FIGS. 5C-5D may also be presented to the user to select a breast shape profile. FIG. 5C shows a portion 500C of an exemplary user interface showing illustrations allowing the user/customer to select from shapes including Round (breasts that are equally full at the top and bottom), Shallow Top/Full Bottom (breasts that are equally full at the top and bottom), and East/West (breasts that are wide set with tissue that rests mostly on the sides of the body), Pendulous (breasts that consist of soft or deflated tissue and often point straight downward with the weight closer to the nipple), and Uneven (No two breasts are perfectly even; In this case we are referencing breasts that are a cup size in difference). FIG. 5D illustrates an exemplary user interface 500D that allows the user/customer to zoom in on the breast shape image and rotate the image using a 360 degree spinner to see the breast shape from different angles. Exemplary user interface 500D may be present in all of the breast shape profile, shoulder slope type, and bra coverage questions as needed.

FIG. 5E illustrates an exemplary user interface 500E that allows the user/customer to select a bra coverage preference: Minimal (bra that offers minimal coverage), Medium (bra that covers three-quarters of the breast), and Full (bra that completely covers the breast).

In one embodiment of the invention, the shape data as described above may be used to provide the user/customer with bra wardrobe and style recommendations. After the customer self-identifies her breast and body shape, recommendation engine assesses the size recommendations, breast shape data and body shape data and makes a unique wardrobe recommendation for the customer. The breast shape data and body shape data may be used in conjunction with knowledge of garment construction embedded within garment database 160 (e.g., wire shape, cup shape/gauge, strap placement, center front height, back wing width) to generate wardrobe recommendations comprising a customized selection of garments (e.g., bras).

An exemplary user interface 600 showing recommended bra size and a set of bra wardrobe recommendations is shown in FIG. 6. In one embodiment of the invention, user interface 600 presents the user with a recommended bra size and breast shape 610. In one embodiment of the invention, the recommended bra size is calculated by sizing engine 140 as discussed herein, and the recommended breast shape is determined based on user self-assessment as discussed herein. In other embodiments of the invention, it is contemplated that breast shape may alternatively be determined through measurements and analysis derived from image capture and/or video scans of the wearer's breasts, one or more sizing table lookups, or other automated methods as discussed above.

User interface 600 may also present a set of bra wardrobe recommendations to help the customer build a complete bra wardrobe. In one embodiment of the invention, such recommendations may include a primary wardrobe recommendation 620 comprising the top 2 best fit styles overall based on the customer's size and shape, as determined by wardrobe engine 150 within recommendation engine 130, and a secondary wardrobe recommendation 630 comprising the top 4 best fit styles per wardrobe solution, based on the customer's size and shape. Exemplary wardrobe solution categories may vary in accordance with consumer demand, product availability, and fashion trends, and in one embodiment of the invention may include “Ultimate Comfort”, “Ultimate Lift™”, “T-Shirt”, “Back & Side Smoothing”, “Strapless”, “Sport”, “Minimizer”, “Cooling”, “Comfort Wire™”, “Lace/Pretty”, “Date Night”, and “Racerback/Convertible”.

To determine the secondary wardrobe recommendation 630, the top 4 styles for each wardrobe solution category are determined. In one embodiment of the invention the following process occurs:

(1) Run a query of garment database 160 to obtain a list of styles in the customer's primary size.

(2) Score the styles against the customer's shape responses. Each style is rated against how well it delivers to each of the “shape” attributes (e.g., height and weight, breast tissue type, shoulder sloping, breast shape, and coverage preference) designated by the customer. For example, for a particular style, a score of 1-9 may be assigned to each style attribute, with 9 being an “excellent” rating and 1 being a “do not recommend” rating. A style is scored based on the lowest rating.

(3) The top 4 scoring styles for each wardrobe solution category are recommended. In the case of a tie for the 4th place solution, the styles are ranked for each solution. The higher ranked style will be recommended. Ranking of a style may be a general ranking associated with the style. Alternatively, the ranking may be generated dynamically for a customer based on one or more customer profile attributes such as the aforementioned style attributes, or style or lifestyle preferences associated with the customer that may be stored in a customer profile database communicatively coupled to recommendation engine 130 and/or wardrobe engine 150.

Next, the top two scoring styles from among all wardrobe solution categories are recommended to the customer as primary wardrobe recommendation 620. In one embodiment of the invention, only one style per solution can be recommended in the top 2 overall recommendations. If there is a tie for the second place for the top two styles from two different wardrobe solution categories, to break the tie in one embodiment of the invention the style from the higher ranked wardrobe solution category will be recommended. Ranking of a wardrobe solution category may be a general ranking associated with the solution category. Alternatively, the ranking may be generated dynamically for a customer based on one or more customer profile attributes such as the aforementioned style attributes, or style or lifestyle preferences associated with the customer that may be stored in a database including customer profiles, for example, that may be communicatively coupled to recommendation engine 130 and/or wardrobe engine 150.

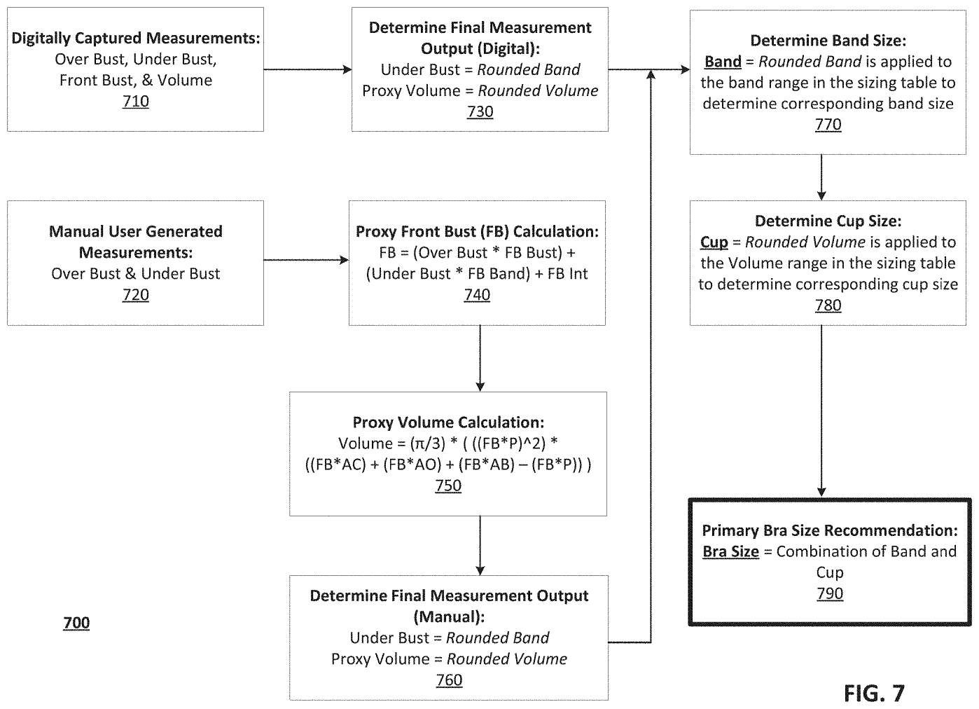

FIG. 7 illustrates a flow diagram of a bra size determination method 700 according to an embodiment of the invention. In step 710, digitally captured measurements are generated by image processing and measurement extraction engine 120 and transmitted to sizing engine 140 within recommendation engine 130. In one embodiment of the invention, image processing and measurement extraction engine 120 generates 4 preliminary measurements from the full-body digital image captures and/or scans of the customer, including a preliminary over bust measurement, a preliminary under bust measurement, a preliminary front bust measurement, and a preliminary volume measurement. At step 730, a final under bust measurement is generated as a rounded band measurement, that rounds the preliminary under bust measurement to the nearest one-eighth of an inch. A proxy volume measurement is also generated at step 730 as a rounded volume measurement, that rounds the preliminary volume measurement to the nearest whole number (units in cubic centimeters or cc's). At step 770, the rounded band measurement is applied to the Band range in a sizing table generated according to one or more embodiments of the invention described herein, to determine a corresponding band size. At step 780, the rounded volume measurement is applied to the Volume range in the sizing table to determine a corresponding cup size. At step 790 a primary bra size recommendation is generated by combining the band size and the cup size determined in steps 770 and 780, and returned to the customer at user application 110.

Alternatively, in step 720, the customer may measure herself with a measuring tape to generate over bust and under bust measurements, which are entered by the customer into user interface of application 110 and transmitted directly to recommendation engine 130. In step 740, a proxy Front Bust measurement is calculated as shown in step 740 in FIG. 7, and then used to determine a proxy Volume calculation in step 750 using the calculation as shown in step 750 of FIG. 7. Thus, for the manual measurement method:

(1) a Proxy Front Bust measurement is calculated using the user input of Over Bust:

Front_Bust=(Over_Bust*FB_Bust)+(Under_Bust*FB_Band)+FB_Int

(2) a Proxy Volume measurement is calculated using the Proxy Front Bust measurement:

Volume=(PI/3)*((Front_Bust*P)\hat{ }2)*((Front Bust*AC)+(Front_Bust*AO)+(Front_Bust*AB)−(Front_Bust*P))), and the variables are defined as follows:

FB Int: Interpreted front bust intercept factor=−4.26205

FB Band: Interpreted front band slope factor=−0.78834

FB Bust: Interpreted front bust slope factor=1.233188

AC: Apex to center=0.53

AO: Apex to outer=0.59

AB: Apex to bottom=0.47

P: Projection=0.3

PI (π): Pi (the ratio of a circle's circumference to its diameter)

At step 760, a final under bust measurement is generated as a rounded band measurement, that rounds the preliminary under bust measurement to the nearest one-eighth of an inch. A final proxy volume measurement is also generated at step 760 as a rounded volume measurement, that rounds the preliminary proxy volume calculation to the nearest whole number (units in cubic centimeters or cc's). At step 770, the rounded band measurement is applied to the Band range in a sizing table generated according to one or more embodiments of the invention described herein, to determine a corresponding band size. At step 780, the rounded volume measurement is applied to the Volume range in the sizing table to determine a corresponding cup size. As described above with respect to the digitally captured body measurements, similarly for the manual user generated measurements at step 790 a primary bra size recommendation is generated by combining the band size and the cup size determined in steps 770 and 780, and returned to the customer at user application 110.

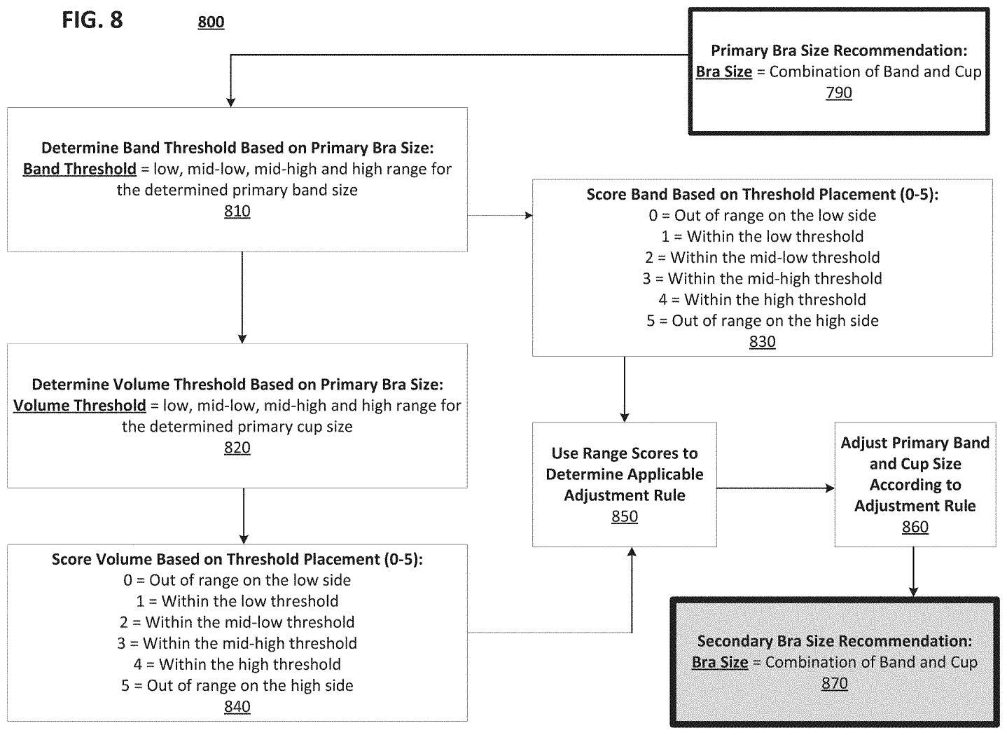

FIG. 8 illustrates a flow diagram of another bra size determination method 800 according to an embodiment of the invention. In some embodiments of the invention, the primary bra size recommendation from step 790 in FIG. 7 is used to generate a secondary bra size recommendation for bra wearers that may be between sizes, and/or may be more comfortable in a bra that is adjusted slightly in band and/or cup size depending on the type and/or style of bra. In one embodiment of the invention, the secondary bra size recommendation may be generated and returned to the customer at user application 110 at a different location on the user interface from the primary bra size recommendation, such as on a page displaying a bra style recommendation where a secondary bra size recommendation may be needed, if one or more known attributes of the bra style being recommended may indicate that the secondary bra size recommendation is desired (e.g., cups are molded and/or have no stretch, or cups are seamless and made of stretchy material). In addition to bra style, a secondary bra size recommendation gives the customer an option that may be more in line with her expectation or desired sizing versus what the primary result shows. For example, if the customer doesn't think the primary bra size recommendation is accurate based on their perceived size or from previous purchases, the secondary bra size recommendation can offer another option that may be more in line with the customer's expectations or needs. At step 810 of FIG. 8, a set of band thresholds is determined based on the under bust measurement used for the primary bra size recommendation. At step 820, a set of cup thresholds is also determined based on the volume measurement used for the primary bra size recommendation. In one embodiment of the invention, there are 4 thresholds for both band and volume:
Low (the “Min” measurement correlated to that primary size from the sizing table)
Mid-Low (between the “Min” and “Mid” of measurements relating to that primary size from the sizing table)
Mid-High (between the “Mid” and “Max” of measurements relating to that primary size from the sizing table)
High (the “Max” measurement correlated to the primary size from the sizing table).

The Mid-Low and Mid-High points for each measurement are determined in one embodiment of the invention as follows:

Band Mid-Low=Mid−((Mid−Min)*85%)

Band Mid-High=Mid+((Mid−Min)*85%)

Volume Mid-Low=Mid−((Mid−Min)*15%))

Volume Mid-High=Mid+((Mid−Min)*15%)

At step 830, the under bust measurement, or alternatively the rounded band measurement, is scored with a range score from zero to five (0 to 5) based on the placement of the under bust (or rounded band) measurement within the band thresholds. And at step 840, the volume measurement, or alternatively the rounded volume measurement, is scored with a range score from zero to five (0 to 5) based on the placement of the volume measurement within the volume thresholds:
0=Out of range on the Low side
1=Within the Low threshold (e.g., between the Low and Mid-Low Thresholds)
2=Within the Mid-Low threshold (e.g., between the Mid-Low and Mid Thresholds)
3=Within the Mid-High threshold (e.g., between the Mid and Mid-High Thresholds)
4=Within the High threshold (e.g., between the Mid-High and High Thresholds)
5=Out of range on the High side

At step 850, the range scores are used to determine an applicable adjustment rule as provided below in one embodiment of the invention:

Sister Down: Qualifier: Band range is low to mid-low II Bust range is mid-low to mid-high; Action: Adjust band down 1 size II Adjust cup up one size

Sister Up: Band range is mid-high to high II Bust range is mid-low to mid-high; Action: Adjust band up one size II Adjust cup down 1 size

Band Down: Qualifier: Band range is low II Bust range is low; Action: Adjust band down 1 size II Keep cup size the same

Band Up: Qualifier: Band range is high II Bust range is high; Action: Adjust band up one size II Keep cup size the same

Cup Down: Qualifier: Band range is mid-low to mid-high II Bust range is low; Action: Keep band size the same II Adjust cup down 1 size

Cup Up: Qualifier: Band range is mid-low to mid-high II Bust range is high; Action: Keep band size the same II Adjust cup up 1 size

Band−/Cup++: Qualifier: Band range is low // Bust range is high; Action: Adjust band down 1 size // Adjust cup up 2 sizes

Band+/Cup−−: Qualifier: Band range is high // Bust range is low; Action: Adjust band up 1 size // Adjust cup down 2 sizes

Once an applicable adjustment rule is determined in step 850, the primary band and cup sizes are adjusted in step 860 according to the applicable adjustment rule, and a secondary bra size recommendation comprising a band and cup size is generated in step 870.

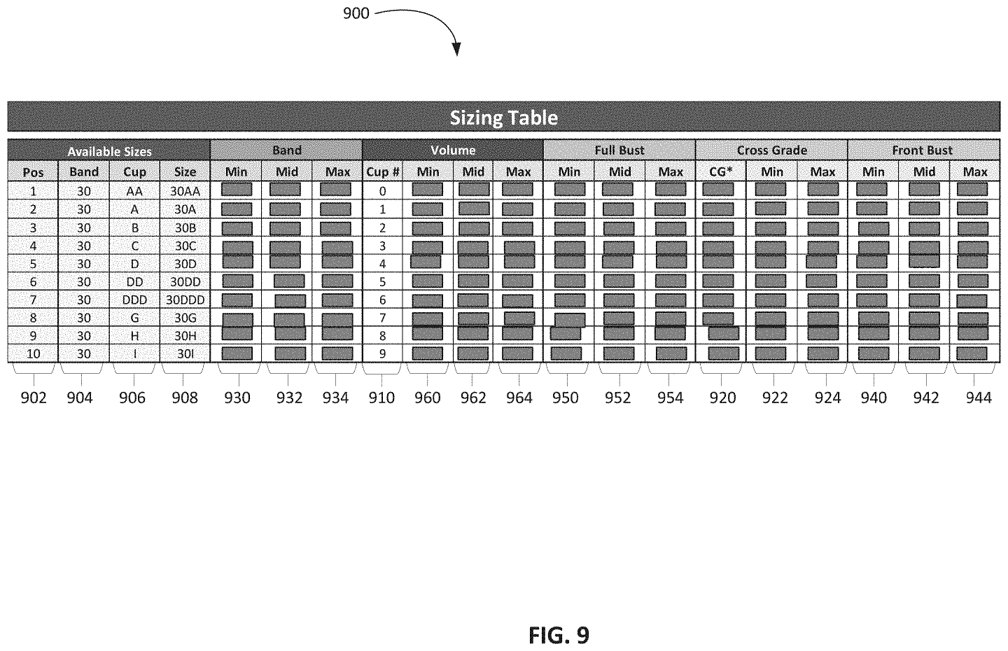

FIG. 9 illustrates a portion of an exemplary sizing table 900 according to one embodiment of the present invention. In one embodiment of the invention, there are an additional 8 sections that cover a range of size possibilities from 30AA through 46I. Other embodiments of the invention may have a larger, smaller, and/or different range of sizes. Exemplary sizing table 900 shows the sizing grid for band 30 sizes ranging from 30AA-30I used in one embodiment of the invention. Each category (e.g., Band, Volume, Full Bust, Cross Grade, Front Bust) has its own logic utilizing regression logic as described below with respect to FIG. 9, to determine the appropriate range as described further below. However, the ranges are mostly used to get the “mid” or median numbers as described below, which is used in the sizing algorithm in one embodiment of the invention.

Measurement data entries in sizing table 900 comprising proprietary data derived from actual customer measurements are redacted. In one embodiment of the invention, real-world measurement samples may be obtained from tens, hundreds, thousands, or more “customers” (e.g., >500 women and/or bra-wearers wearing their best-fitting bra and/or a control bra of known size) to provide “ground truth” measurement data that may comprise the data sources for a regression analysis (such as may be generated using spreadsheet or data analysis programs known to those skilled in the art, such as Excel™ manufactured by Microsoft Corporation). The regression analysis may then be used to determine the minimum, median, and maximum values used in the sizing table 900. In one embodiment of the invention, such real-world measurement data and/or sizing table 900 may also be used to calibrate and/or establish a baseline for accuracy of the digitally derived measurements obtained from the image captures.

In one embodiment of the invention, a sizing table 900 may include the following:

Non-Calculated Fields:

Position: Shows the position of the size element and its corresponding measurements. In one embodiment of the invention, position values can range from 1-90. Position is shown in FIG. 9 at column 902.

Band: Portion of the bra that runs around the ribcage of the wearer. The band size is usually an even number ranging from 30 to 46. Band is shown in FIG. 9 at column 904.

Cup: Portion of the bra that contains the breast tissue and is usually represented with a letter or combination of letters. In one embodiment of the invention, these cup sizes are represented as: A, B, C, D, DD, DDD, E, F, G, H, I. Different series of letters and letter combinations representing cup sizes are contemplated in embodiments of the invention. Cup is shown in FIG. 9 at column 906.

Bra Size: A size recommendation is the combination of the Band and Cup usually shown in number/letter format, e.g., 40DD. Bra size is shown in FIG. 9 at column 908.

Cup #: Each cup is created using a cup # that represents its technical grading or cross grade (CG*). In one embodiment of the invention shown in FIG. 9, there are 18 cup #'s ranging from 0-17, only a subset of which may be utilized with a particular Band size. Cup # is shown in FIG. 9 at column 910.

CG*: A growth factor used to determine the increase (in inches) from one cup to the next. In one embodiment of the invention, CG* values are established by manufacturer or industry standard. CG* values are redacted, but may be shown in FIG. 9 at column 920.

Cross Grade Min (CGMin): Minimum cross grade value for each cup #. In one embodiment of the invention, CGMin values are established by manufacturer or industry standard. In one embodiment of the invention, the starting CGMin value is 5.75 for cup #0. CGMin values are redacted, but may be shown in FIG. 9 at column 922.

Cross Grade Max (CGMax): Maximum cross grade value for each cup #. In one embodiment of the invention, CGMax values are established by manufacturer or industry standard. In one embodiment of the invention, the cross graded max value is 0.001 less than the CGMin of the next cup up in the table (i.e., Cup #1 CGMin−0.001=CGMax of Cup #0). CGMax values are redacted, but may be shown in FIG. 9 at column 924.

Calculated Fields and Definitions:

Apex to Center (AC): A calculation defined as the measurement of breast apex to the center point of ribcage. This factor is used in the Volume calculation as provided below.

Apex to Outer (AO): A calculation defined as the measurement of breast apex to the outer point where the breast meets the ribcage. This factor is used in the Volume calculation as provided below.

Apex to Bottom (AB): A calculation defined as the measurement of breast apex to the bottom point where the breast meets the ribcage. This factor is used in the Volume calculation as provided below.

Projection (P): A calculation defined as the measurement of height from center ribcage to the apex of each breast. This factor is used in the Volume calculation as provided below.

Under Bust (UB) Calculation Logic: Regression analysis is performed as described below between the measured Band values for each bra size and Under Bust Median (UBMid) for that bra size to determine a minimum and maximum slopes and intercept. UBMin, UBMid, and UBMax values are redacted, but may be shown in FIG. 9 at column 930, column 932, and column 934 respectively.

Minimum (UBMin): UBMin=(Band*Band_Minimum_Slope)+(UBMid*UBMin_Slope1)+UBMin_Intercept1

Median (UBMid): This represents the median measurement (in inches) for each band size

Maximum (UBMax): UBMax=(Band*Band_Maximum_Slope)+(UBMid*UBMax_Slope1)+UBMax_Intercept1

Front Bust (FB) Calculation Logic: Regression analysis is performed as described below between the Under Bust and Cross Grade to determine a minimum and maximum slopes and intercept. FBMin, FBMid, and FBMax values are redacted, but may be shown in FIG. 9 at column 940, column 942, and column 944 respectively.

Minimum (FBMin): (UBMin*UBMin_Slope2)+(CGMin*CGMin_Slope1)+CBMin_Intercept1

Median (FBMid): The median point between FBMin and FBMax

Maximum (FBMax): (UBMax*UBMax_Slope2)+(CGMax*CGMax_Slope1)+CGMax_Intercept1

Over Bust (OB) Calculation Logic: Regression analysis is performed as described below between the Under Bust and Front Bust to determine a minimum and maximum slopes and intercept. OBMin, OBMid, and OBMax values are redacted, but may be shown in FIG. 9 at column 950, column 952, and column 954 respectively under the heading “Full Bust”.

Minimum (OBMin): (UBMin*UBMin_Slope3)+(FBMin*FBMin_Slope1)+FBMin_Intercept1

Median (FBMid): The median point between OBMin and OBMax

Maximum (FBMax): (UBMax*UBMax_Slope3)+(FBMax*FBMax_Slope1)+FBMax_Intercept1

Volume (Vol) Calculation Logic: Proxy calculation using cup # and the corresponding front bust median to determine the four components of the volume equation. VolMin, VolMid, and VolMax values are redacted, but may be shown in FIG. 9 at column 960, column 962, and column 964 respectively.

Apex to Center (AC): Average median measurement for front bust*53%

Apex to Outer (AO): Average median measurement for front bust*59%

Apex to Bottom (AB): Average median measurement for front bust*48.5%

Projection (P): Average median measurement for front bust*30%

Minimum (VolMin): For each Cup #: VolMid*85%

Median (VolMid): For each Cup #: (Pi/3)*((P\hat{ }2)*(AC+AO+AB−P))

Maximum (VolMax): For each Cup #: VolMid*115%

The calculation logic as described above is used to populate sizing table 142 as shown in example table portion 900, a complete version of which comprising all available bra sizes may then be stored in complete form as sizing table 142 in FIG. 1 and used in sizing engine 140 in determining a customer's bra size.

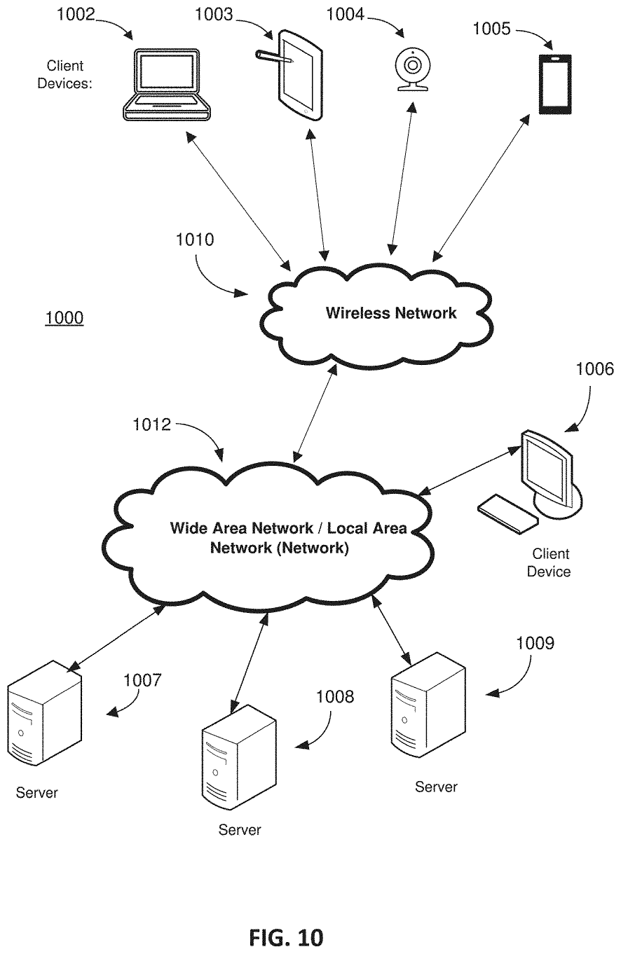

FIG. 10 illustrates components of one embodiment of an environment 1000 in which the invention may be practiced. Not all the components may be required to practice the invention, and variations in the arrangement and type of the components may be made without departing from the spirit or scope of the invention. As shown, the system 1000 includes one or more Local Area Networks (“LANs”)/Wide Area Networks (“WANs”) 1012, one or more wireless networks 1010, one or more wired or wireless client devices 1004 and 1006, mobile or other wireless client devices 1002, 1003, and 1005, and servers 1007-1009, which may include or communicate with one or more data stores or databases (not shown). Various of the client devices 1002-1006 may include, for example, desktop computers, laptop computers, set top boxes, webcams, tablets, monitors, cell phones, smart phones, devices for interfacing with, or viewing user interfaces, dashboards or analytics relating to, bra size measurement and bra style recommendation related systems or methods, etc. The servers 1007-1009 can include, for example, one or more application servers, content servers, search servers, database servers, database management or SQL servers, other servers relating to bra size measurement and bra style recommendation related systems, etc.

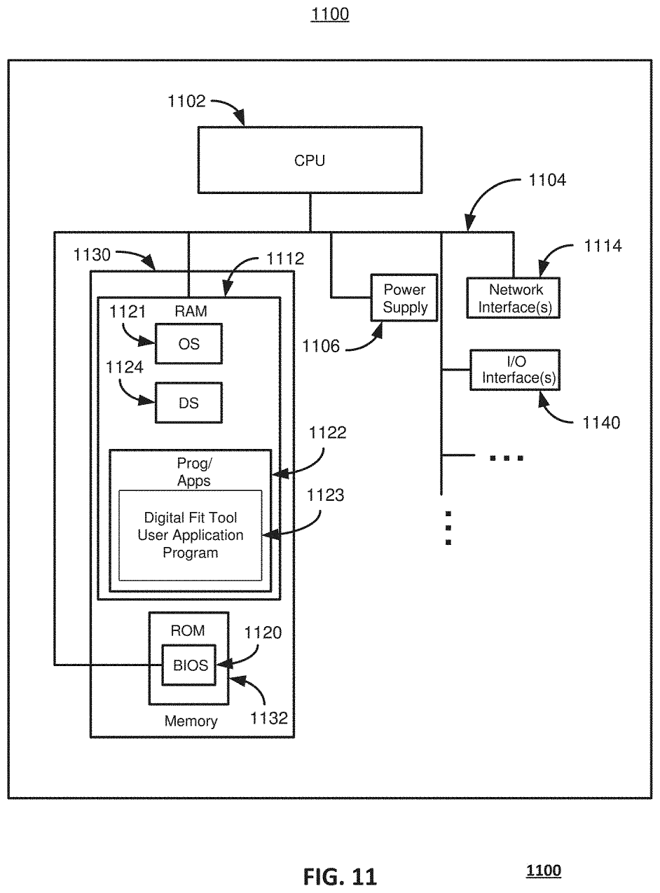

FIG. 11 illustrates a block diagram of an electronic device 1100 that can implement one or more aspects of bra size measurement and bra recommendation related systems and methods according to embodiments of the invention. Instances of the electronic device 1100 may include servers, e.g., servers 1007-1009, and client devices, e.g., client devices 1002-1006. In general, the electronic device 1100 can include a processor/CPU 1102, memory 1130, a power supply 1106, and input/output (I/O) components/devices 1140, e.g., cameras, microphones, speakers, displays, touchscreens, keyboards, mice, keypads, microscopes, gyroscopes, GPS components, etc., which may be operable, for example, to take and record digital photos and videos, scan digital images and digital videos, provide graphical user interfaces, dashboards, etc.

A user may provide input via a touchscreen of an electronic device 1100. A touchscreen may determine whether a user is providing input by, for example, determining whether the user is touching the touchscreen with a part of the user's body such as his or her fingers. The electronic device 1100 can also include a communications bus 1104 that connects the aforementioned elements of the electronic device 1100. Network interfaces 1114 can include a receiver and a transmitter (or transceiver), and one or more antennas for wireless communications.

The processor 1102 can include one or more of any type of processing device, e.g., a Central Processing Unit (CPU), and a Graphics Processing Unit (GPU). Also, for example, the processor can be central processing logic, or other logic, may include hardware, firmware, software, or combinations thereof, to perform one or more functions or actions, or to cause one or more functions or actions from one or more other components. Also, based on a desired application or need, central processing logic, or other logic, may include, for example, a software-controlled microprocessor, discrete logic, e.g., an Application Specific Integrated Circuit (ASIC), a programmable/programmed logic device, memory device containing instructions, etc., or combinatorial logic embodied in hardware. Furthermore, logic may also be fully embodied as software.

The memory 1130, which can include Random Access Memory (RAM) 1112 and Read Only Memory (ROM) 1132, can be enabled by one or more of any type of memory device, e.g., a primary (directly accessible by the CPU) or secondary (indirectly accessible by the CPU) storage device (e.g., flash memory, magnetic disk, optical disk, solid state drive and the like). The ROM 1132 can also include Basic Input/Output System (BIOS) 1120 of the electronic device.

The RAM can include an operating system 1121, data storage 1124, which may include one or more databases, and programs and/or applications 1122 and a bra size measurement and bra style recommendation application program 1123. The bra size measurement and bra style recommendation application program 1123 is intended to broadly include all programming, applications, algorithms, software and other and tools necessary to implement or facilitate methods and systems according to embodiments of the invention. Elements of the bra size measurement and bra style recommendation application program 1123 may comprise recommendation engine 130, image processing and measurement extraction engine 130, or portions thereof, and may exist on a single server computer or be distributed among multiple computers, servers, devices or entities, or sites. Alternatively, elements of bra size and bra style recommendation application program 1123 may comprise user application 110 when running on a client device, e.g., 1002-1006.

The power supply 1106 contains one or more power components and facilitates supply and management of power to the electronic device 1100.

The input/output components, including Input/Output (I/O) interfaces 1140, can include, for example, any interfaces for facilitating communication between any components of the electronic device 1100, components of external devices (e.g., components of other devices of the network or system 1100), and end users. For example, such components can include a network card that may be an integration of a receiver, a transmitter, a transceiver, and one or more input/output interfaces. A network card, for example, can facilitate wired or wireless communication with other devices of a network. In cases of wireless communication, an antenna can facilitate such communication. Also, some of the input/output interfaces 1140 and the bus 1104 can facilitate communication between components of the electronic device 1100, and in an example can ease processing performed by the processor 1102.

Where the electronic device 1100 is a server, it can include a computing device that can be capable of sending or receiving signals, e.g., via a wired or wireless network, or may be capable of processing or storing signals, e.g., in memory as physical memory states. The server may be an application server that includes a configuration to provide one or more applications.

Any computing device capable of sending, receiving, and processing data over a wired and/or a wireless network may act as a server, such as in facilitating aspects of implementations of bra size measurement and bra style recommendation related systems according to embodiments of the invention. Devices acting as a server may include devices such as dedicated rack-mounted servers, desktop computers, laptop computers, set top boxes, integrated devices combining one or more of the preceding devices, etc.

Servers may vary widely in configuration and capabilities, but they generally include one or more central processing units, memory, mass data storage, a power supply, wired or wireless network interfaces, input/output interfaces, and an operating system such as Windows Server, Mac OS X, Unix, Linux, FreeBSD, and the like.

A server may include, for example, a device that is configured, or includes a configuration, to provide data or content via one or more networks to another device, such as in facilitating aspects of an example bra size and style recommendation systems and methods according to embodiments of the invention. One or more servers may, for example, be used in hosting a Web site, such as the web site www.microsoft.com. One or more servers may host a variety of sites, such as, for example, business sites, informational sites, social networking sites, educational sites, wilds, financial sites, government sites, personal sites, and the like.

Servers may also, for example, provide a variety of services, such as Web services, third-party services, audio services, video services, email services, HTTP or HTTPS services, Instant Messaging (IM) services, Short Message Service (SMS) services, Multimedia Messaging Service (MMS) services, File Transfer Protocol (FTP) services, Voice Over IP (VOIP) services, calendaring services, phone services, and the like, all of which may work in conjunction with example aspects of bra size measurement and bra style recommendation related systems according to embodiments of the invention. Content may include, for example, text, images, audio, video, and the like.

In example aspects of bra size measurement and bra style recommendation related systems according to embodiments of the invention, client devices may include, for example, any computing device capable of sending and receiving data over a wired and/or a wireless network. Such client devices may include desktop computers as well as portable devices such as cellular telephones, smart phones, display pagers, Radio Frequency (RF) devices, Infrared (IR) devices, Personal Digital Assistants (PDAs), handheld computers, GPS-enabled devices tablet computers, monitors, sensor-equipped devices, laptop computers, set top boxes, wearable computers, integrated devices combining one or more of the preceding devices, and the like.

Client devices may range widely in terms of capabilities and features. For example, a Web-enabled client device may have a physical or virtual keyboard, data storage (such as flash memory or SD cards), accelerometers, gyroscopes, GPS or other location-aware capability, and a 2D or 3D touch-sensitive color screen on which both text and graphics may be displayed.

Client devices, such as client devices 1002-1006, for example, as may be used in bra size measurement and bra style recommendation related systems according to embodiments of the invention, may run a variety of operating systems, including personal computer operating systems such as Windows, iOS or Linux, and mobile operating systems such as iOS, Android, Windows Mobile, and the like. Client devices may be used to run one or more applications that are configured to send or receive data from another computing device. Client applications may provide and receive textual content, multimedia information, and the like. Client applications may perform actions such as viewing or interacting with analytics or dashboards, interacting with bra size measurement and bra style recommendation related systems or ecommerce sites, capturing digital photo or video images or scans, browsing webpages, using a web search engine, interacting with various apps stored on a smart phone, sending and receiving messages via email, SMS, or MMS, playing games, receiving advertising, watching locally stored or streamed video, or participating in social networks.

In example aspects of bra size measurement and bra style recommendation related systems according to embodiments of the invention, one or more networks, such as networks 1010 or 1012, for example, may couple servers and client devices with other computing devices, including through wireless network to client devices. A network may be enabled to employ any form of computer readable media for communicating information from one electronic device to another. A network may include the Internet in addition to Local Area Networks (LANs), Wide Area Networks (WANs), direct connections, such as through a Universal Serial Bus (USB) port, other forms of computer-readable media, or any combination thereof. On an interconnected set of LANs, including those based on differing architectures and protocols, a router acts as a link between LANs, enabling data to be sent from one to another.

Communication links within LANs may include twisted wire pair or coaxial cable, while communication links between networks may utilize analog telephone lines, cable lines, optical lines, full or fractional dedicated digital lines including T1, T2, T3, and T4, Integrated Services Digital Networks (ISDNs), Digital Subscriber Lines (DSLs), wireless links including satellite links, optic fiber links, or other communications links known to those skilled in the art. Furthermore, remote computers and other related electronic devices could be remotely connected to either LANs or WANs via a modem and a telephone link.

A wireless network, such as wireless network 1010, as in bra size measurement and bra style recommendation related systems according to embodiments of the invention, may couple devices with a network. A wireless network may employ stand-alone ad-hoc networks, mesh networks, Wireless LAN (WLAN) networks, cellular networks, and the like.

A wireless network may further include an autonomous system of terminals, gateways, routers, or the like connected by wireless radio links, or the like. These connectors may be configured to move freely and randomly and organize themselves arbitrarily, such that the topology of wireless network may change rapidly. A wireless network may further employ a plurality of access technologies including 2nd (2G), 3rd (3G), 4th (4G) generation, 5th (5G) generation, Long Term Evolution (LTE) radio access for cellular systems, WLAN, Wireless Router (WR) mesh, and the like. Access technologies such as 2G, 2.5G, 3G, 4G, 5G and future access networks may enable wide area coverage for client devices, such as client devices with various degrees of mobility. For example, a wireless network may enable a radio connection through a radio network access technology such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, and the like. A wireless network may include virtually any wireless communication mechanism by which information may travel between client devices and another computing device, network, and the like.

Internet Protocol (IP) may be used for transmitting data communication packets over a network of participating digital communication networks, and may include protocols such as TCP/IP, UDP, DECnet, NetBEUI, IPX, AppleTalk, and the like. Versions of the Internet Protocol include IPv4 and IPv6. The Internet includes local area networks (LANs), Wide Area Networks (WANs), wireless networks, and long-haul public networks that may allow packets to be communicated between the local area networks. The packets may be transmitted between nodes in the network to sites each of which has a unique local network address. A data communication packet may be sent through the Internet from a user site via an access node connected to the Internet. The packet may be forwarded through the network nodes to any target site connected to the network provided that the site address of the target site is included in a header of the packet. Each packet communicated over the Internet may be routed via a path determined by gateways and servers that switch the packet according to the target address and the availability of a network path to connect to the target site.

The header of the packet may include, for example, the source port (16 bits), destination port (16 bits), sequence number (32 bits), acknowledgement number (32 bits), data offset (4 bits), reserved (6 bits), checksum (16 bits), urgent pointer (16 bits), options (variable number of bits in multiple of 8 bits in length), padding (may be composed of all zeros and includes a number of bits such that the header ends on a 32 bit boundary). The number of bits for each of the above may also be higher or lower.

A “content delivery network” or “content distribution network” (CDN), as may be used in bra size measurement and bra style recommendation related systems according to embodiments of the invention, generally refers to a distributed computer system that comprises a collection of autonomous computers linked by a network or networks, together with the software, systems, protocols and techniques designed to facilitate various services, such as the storage, caching, or transmission of content, streaming media and applications on behalf of content providers. Such services may make use of ancillary technologies including, but not limited to, “cloud computing,” distributed storage, DNS request handling, provisioning, data monitoring and reporting, content targeting, personalization, and business intelligence. A CDN may also enable an entity to operate and/or manage a third party's Web site infrastructure, in whole or in part, on the third party's behalf.

A Peer-to-Peer (or P2P) computer network relies primarily on the computing power and bandwidth of the participants in the network rather than concentrating it in a given set of dedicated servers. P2P networks are typically used for connecting nodes via largely ad hoc connections. A pure peer-to-peer network does not have a notion of clients or servers, but only equal peer nodes that simultaneously function as both “clients” and “servers” to the other nodes on the network.

One embodiment of the present invention includes systems, methods, and a non-transitory computer readable storage medium or media tangibly storing computer program logic capable of being executed by a computer processor.

While the present invention has been particularly described with respect to the illustrated embodiments, it will be appreciated that various alterations, modifications and adaptations may be made based on the present disclosure and are intended to be within the scope of the present invention. While the invention has been described in connection with what are presently considered to be the most practical and preferred embodiments, it is to be understood that the present invention is not limited to the disclosed embodiments but, on the contrary, is intended to cover various modifications and equivalent arrangements included within the scope of the appended claims.

### Definitions

Under Bust: Measures the circumference around the ribcage, parallel to the ground, under the breast tissue. (example units: inches)

Over Bust: Measures the circumference around the body, parallel to the ground, at the fullest part of the bust (also called the apex). (example units: inches)

Front Bust: Measures a portion of the Over Bust circumference where the breast tissue resides. Measurement starts where the breast tissue meets the body on one side, then along the over bust circumference line to where the breast tissue meets the body on the other side. (example units: inches)

Volume: Measures the amount of “space” or cubic capacity of a bra cup (example units: cubic centimeters or cc)

Bra Cup: The portion of the bra that contains the breast tissue.

Cross Grading: Refers to using the same size cup with a different wing or band in order to create a different size instead of using a unique cup for each size produced. To further elaborate, when a longer wing or band is used with the same size cup, the letter assigned to that cup becomes smaller.

Rounded Band: Rounds the Band (Under Bust) measurement to the nearest ⅛.

Rounded Bust: Rounds the Bust (Over Bust) measurement to the nearest ⅛.

Rounded FB: Rounds the Front Bust measurement to the nearest ⅛.

Rounded Volume: Rounds the Volume measurement to the nearest whole number.

Band: Portion of the bra that runs around the ribcage of the wearer. In the United States markets, the band size is usually an even number ranging from 30 through 46.

Band Tier: Each band has a size tier based on under bust measurements.

Cup: Portion of the bra that contains the breast tissue and is usually represented with a letter or combination of letters, e.g., A, B, C, D, DD, DDD, E, F, G, H, I.

Bra Size: A size recommendation is the combination of the Band and Cup usually shown in number/letter format, e.g., 36C.

FB Int: Interpreted front bust intercept factor=−4.26205

FB Band: Interpreted front band slope factor=−0.78834

FB Bust: Interpreted front bust slope factor=1.233188

AC: Apex to center=0.53

AO: Apex to outer=0.59

AB: Apex to bottom=0.47

P: Projection=0.3

PI (n): Pi (the ratio of a circle's circumference to its diameter)

Sizing Algorithm Definitions:

Digital Primary Recommendation:

Band: Determined by placing the rounded band measurement into the optimal band range in the sizing table

Cup: Determined by placing the rounded volume measurement into optimal volume range in the sizing table to determine the corresponding bra cup size

Bra Size: Band and Cup are combined to establish a bra size recommendation

Manual Primary Recommendation:

Band: Determined by placing the rounded band measurement into the optimal band range in the sizing table

Cup: Determined using the following steps:

(1) Front Bust is calculated using the user input of Over Bust:

Front_Bust=(Over_Bust*FB_Bust)+(Under_Bust*FB_Band)+FB_Int

(2) Volume is calculated using the Front Bust:

Volume=(PI/3)*((Front_Bust*P)\hat{ }2)*((Front_Bust*AC)+(Front_Bust*AO)+(Front_Bust*AB)−(Front_Bust*P)))

(3) Rounded Volume is used to determine the optimal volume range and corresponding bra cup size

Bra Size: Band and Cup are combined to establish a bra size recommendation

Secondary Size Recommendation:

Band Score: Determined by placing the Under Bust measurement into band range and scoring it based on where it falls within the range (0-5; with 0 being the lowest end of range and 5 being the highest)

Cup Score: Determined by placing the Volume measurement into volume range and scoring it based on where it falls within the range (0-5; with 0 being the lowest end of range and 5 being the highest)

Rule: Based on Band and Cup Scores, an applicable rule is determined for a secondary bra size recommendation (See “Rule Definitions” below.)

### Rule Definitions

Sister Down: Qualifier: Band range is low to mid-low II Bust range is mid-low to mid-high; Action: Adjust band down 1 size II Adjust cup up one size

Sister Up: Qualifier: Band range is mid-high to high II Bust range is mid-low to mid-high; Action: Adjust band up one size II Adjust cup down 1 size

Band Down: Qualifier: Band range is low II Bust range is low; Action: Adjust band down 1 size II Keep cup size the same

Band Up: Qualifier: Band range is high II Bust range is high; Action: Adjust band up one size II Keep cup size the same

Cup Down: Qualifier: Band range is mid-low to mid-high II Bust range is low; Action: Keep band size the same II Adjust cup down 1 size

Cup Up: Qualifier: Band range is mid-low to mid-high II Bust range is high; Action: Keep band size the same II Adjust cup up 1 size

Band−/Cup++: Qualifier: Band range is low // Bust range is high; Action: Adjust band down 1 size // Adjust cup up 2 sizes

Band+/Cup−−: Qualifier: Band range is high // Bust range is low; Action: Adjust band up 1 size // Adjust cup down 2 sizes

### Sizing Table Definitions

Band Range: Band measurement range (minimum, median, maximum) for each bra size

Band Threshold: Band range broken down even further to show low, mid-low, mid-high, and high thresholds within the (minimum, median, maximum) range for each bra size

Over (Full) Bust Range: Bust measurement range (minimum, median, maximum) for each bra size

Front Bust Range: Front Bust measurement range (minimum, median, maximum) range for each bra size

Volume Range: Volume measurement range (minimum, median, maximum) for each bra size

Volume Threshold: Volume range broken down even further to show low, mid-low, mid-high, and high thresholds within the (minimum, median, maximum) range for each bra size.

What is claimed is:

1. A method for automatically providing a bra size recommendation for a wearer via a user device, comprising:
a. receiving a height value, a weight value, and one or more full-body digital images of the wearer transmitted by the wearer from a user interface on the user device;
b. analyzing, by a computer, the one or more full-body digital images, wherein the analyzing comprises generating an over bust measurement, an under bust measurement, a front bust measurement, and a volume measurement;
c. determining a plurality of output measurements comprising at least a rounded band measurement based on at least the under bust measurement, and a rounded volume measurement based on at least the volume measurement;
d. determining a recommended band size, wherein the rounded band measurement is within an optimal band range for the recommended band size in at least one sizing table;
e. determining a recommended cup size, wherein the cup size on the rounded volume measurement is within an optimal volume range for the recommended cup size in the at least one sizing table; and
f. transmitting to the user device for display on the user interface, the bra size recommendation comprising the recommended band size and recommended cup size.

2. The method of claim 1, wherein the one or more full-body digital images comprise a full-body digital image of the wearer standing with feet apart and a full-body digital image of the wearer standing with feet together.

3. The method of claim 1, wherein the one or more full-body digital images comprise at least one digital video of a 360-degree rotation of the full body of the wearer.

4. The method of claim 1, wherein the one or more full-body digital images of the wearer are captured by a scan process using the camera and initiated by the wearer via the user interface on the user device.

5. The method of claim 4, wherein the scan process further comprises displaying a gyroscope on the user interface to indicate an angle to position the user device for the scan process to capture the one or more full-body digital images.

6. The method of claim 4, wherein the scan process further comprises generating an error message on the user interface when the full body of the wearer is not visible to the camera.

7. The method of claim 4, wherein the scan process further comprises generating an error message on the user interface when the wearer is wearing too much clothing or loose clothing.

8. The method of claim 1, further comprising receiving one or more shape attributes of the wearer via the user interface on the user device, and generating one or more bra style recommendations for display on the user interface.

9. The method of claim 7, wherein the one or more shape attributes comprises one or more of a breast tissue attribute, a shoulder slope attribute, a breast shape attribute, and a coverage level attribute.

10. A system for automatically providing a bra size recommendation and one or more bra style recommendations for a wearer on a user device, comprising:
a. a measurement extraction engine configured to:
i. receive a height value, a weight value, and one or more full-body digital images of the wearer transmitted by the wearer from a user interface on the user device;
ii. analyze the one or more full-body digital images to extract measurement data comprising an over bust measurement, an under bust measurement, a front bust measurement, and a volume measurement for the wearer; and
b. a recommendation engine communicatively coupled to the measurement extraction engine, comprising:
i. a bra sizing engine configured to:
1. receive the measurement data from the measurement extraction engine;
2. determine a plurality of output measurements comprising at least a rounded band measurement based on at least the under bust measurement, and a rounded volume measurement based on at least the volume measurement;
3. determine a recommended band size, wherein the rounded band measurement is within an optimal band range for the recommended band size in at least one sizing table;
4. determine a recommended cup size, wherein the cup size on the rounded volume measurement is within an optimal volume range for the recommended cup size in the at least one sizing table; and
5. transmit to the user device for display on the user interface, the bra size recommendation comprising the recommended band size and recommended cup size; and
ii. a wardrobe engine communicatively coupled to the bra sizing engine and configured to:
1. receive the bra size recommendation from the bra sizing engine;
2. receive one or more shape attributes of the wearer via the user interface on the user device; and
3. generate one or more bra style recommendations;
4. transmit the one or more bra style recommendations for display on the user interface.

11. The system of claim 10, wherein the one or more full-body digital images comprise a full-body digital image of the wearer standing with feet apart and a full-body digital image of the wearer standing with feet together.

12. The system of claim 10, wherein the one or more full-body digital images comprise at least one digital video of a 360-degree rotation of the full body of the wearer.

13. The system of claim 10, wherein the one or more full-body digital images of the wearer are captured by a scan process using the camera and initiated by the wearer via the user interface on the user device.

14. The system of claim 13, wherein the scan process further comprises displaying a gyroscope on the user interface to indicate an angle to position the user device for the scan process to capture the one or more full-body digital images.

15. The system of claim 13, wherein the scan process further comprises generating an error message on the user interface when the full body of the wearer is not visible to the camera.

16. The system of claim 13, wherein the scan process further comprises generating an error message on the user interface when the wearer is wearing too much clothing or loose clothing.

17. The system of claim 10, wherein the one or more shape attributes comprises one or more of a breast tissue attribute, a shoulder slope attribute, a breast shape attribute, and a coverage level attribute.

18. A non-transitory computer readable medium comprising instructions executable by at least one computer processor on one or more user devices having a camera to execute processing comprising:
a. capturing a height value, a weight value, and one or more full-body digital images of a wearer on the one or more user devices;
b. transmitting on a computer network the height value, the weight value, and the one or more full-body digital images of the wearer to a bra size recommendation system;
c. receiving from the bra size recommendation system, via the computer network, a bra size recommendation comprising the recommended band size and recommended cup size and one or more bra style recommendations, wherein the bra size recommendation system comprises:
i. a measurement extraction engine configured to:
1. receive a height value, a weight value, and one or more full-body digital images of the wearer transmitted by the wearer from a user interface on the user device;
2. analyze the one or more full-body digital images to extract measurement data comprising an over bust measurement, an under bust measurement, a front bust measurement, and a volume measurement for the wearer; and
ii. a recommendation engine communicatively coupled to the measurement extraction engine, comprising:
1. a bra sizing engine configured to:
a. receive the measurement data from the measurement extraction engine;
b. determine a plurality of output measurements comprising at least a rounded band measurement based on at least the under bust measurement, and a rounded volume measurement based on at least the volume measurement;
c. determine a recommended band size, wherein the rounded band measurement is within an optimal band range for the recommended band size in at least one sizing table;
d. determine a recommended cup size, wherein the cup size on the rounded volume measurement is within an optimal volume range for the recommended cup size in the at least one sizing table; and
e. transmit to the user device for display on the user interface, the bra size recommendation comprising the recommended band size and recommended cup size; and
2. a wardrobe engine communicatively coupled to the bra sizing engine and configured to:
a. receive the bra size recommendation from the bra sizing engine;
b. receive one or more shape attributes of the wearer via the user interface on the user device;
c. generate one or more bra style recommendations; and
d. transmit the one or more bra style recommendations via the computer network to the user device for display on the user interface; and
d. displaying the bra size recommendation and the one or more bra style recommendations on the user interface.

19. The computer readable medium of claim 18, wherein the one or more full-body digital images comprises a full-body digital image of the wearer standing with feet apart and a full-body digital image of the wearer standing with feet together.

20. The computer readable medium of claim 18, wherein the one or more full-body digital images comprises at least one digital video of a 360-degree rotation of the full body of the wearer.

21. The computer readable medium of claim 18, wherein the one or more full-body digital images of the wearer are captured by a scan process using the camera and initiated by the wearer via the user interface on the user device.

22. The computer readable medium of claim 21, wherein the scan process further comprises displaying a gyroscope on the user interface to indicate an angle to position the user device for the scan process to capture the one or more full-body digital images.

23. The computer readable medium of claim 21, wherein the scan process further comprises generating an error message on the user interface when the full body of the wearer is not visible to the camera.

24. The computer readable medium of claim 21, wherein the scan process further comprises generating an error message on the user interface when the wearer is wearing too much clothing or loose clothing.

25. The computer readable medium of claim 18, wherein the one or more shape attributes comprises one or more of a breast tissue attribute, a shoulder slope attribute, a breast shape attribute, and a coverage level attribute.

26. The computer readable medium of claim 18, wherein
a. the over bust measurement comprises an over bust circumference around the body of the wearer, parallel to a ground plane, at an apex part of a breast of the wearer; and
b. the front bust measurement comprises a portion of the over bust circumference that includes a first front bust endpoint where breast tissue meets a first side of the body of the wearer along a front portion of the body of the wearer to a second front bust endpoint where breast tissue meets a second side of the body of the wearer.

27. The computer readable medium of claim 18, further comprising:
a. capturing an over bust measurement value and an under bust measurement value of the wearer on the one or more user devices instead of capturing the one or more full-body digital images; and
b. determining the over bust measurement as the over bust measurement value, the under bust measurement as the under bust measurement value, the front bust measurement as a function of the over bust measurement; and the volume measurement as a function of the front bust measurement.

28. The computer readable medium of claim 27, wherein the front bust measurement is equal to the sum of:
a. the product of the over bust measurement and an interpreted front bust (IFB) bust slope;
b. the product of the under bust measurement and an IFB band slope; and
c. an IFB intercept factor.

29. The computer readable medium of claim 27, wherein the volume measurement is equal to: (PI/3)*(((Front_Bust*P)\hat{ }2)*((Front_Bust*AC)+(Front_Bust*AO)+(Front_Bust*AB)−(Front_Bust*P))) where PI is the ratio of a circle's circumference to its diameter, Front_Bust is the front bust measurement, P is a projection value, AC is an apex to center value, AO is an apex to outer value, and AB is an apex to bottom value.

30. The computer readable medium of claim 18, wherein the at least one sizing table comprises a database having:
a. a plurality of band sizes, wherein each band size is associated with a band range comprising a minimum band, a median band, and a maximum band derived from a regression analysis between under bust measurements from a plurality of measurement samples and a pre-defined under bust median value associated with the band size;
b. a plurality of cup sizes associated with each band size, wherein each cup size is associated with a volume range comprising a minimum volume, a median volume, and a maximum volume, and each distinct band size and cup size pairing comprises a bra size.

31. The computer readable medium of claim 30, further comprising:
a. a front bust range associated with each bra size, wherein each front bust range comprises a minimum front bust, a median front bust, and a maximum front bust, and is derived from a regression analysis of the under bust measurements from the plurality of measurement samples and a pre-defined cross grade value for each bra size; and
b. an over bust range associated with each bra size, wherein each over bust range comprises a minimum over bust, a median over bust, and a maximum over bust, and is derived from a regression analysis between the under bust measurements from the plurality of measurement samples and the front bust range associated with the bra size.

32. The computer readable medium of claim 31, wherein the volume range is calculated based on the median front bust associated with the bra size.
